(19) United States
(12) Patent Application Publication
(10) Pub. No.: US 2022/0092700 A1
(43) Pub. Date: Mar. 24, 2022

(54) EVALUATION RESPONSE SYSTEM AND METHOD

(71) Applicant: Briza, Inc., Austin, TX (US)

(72) Inventors: Rishi Sharma, Toronto (CA); Luiz Guilherme D'Abruzzo Pereira, São Paulo (BR); David Horák, Toronto (CA); Charles R. Walden, Austin, TX (US)

(21) Appl. No.: 17/481,934

(22) Filed: Sep. 22, 2021

Related U.S. Application Data
(60) Provisional application No. 63/081,730, filed on Sep. 22, 2020.
(60) Provisional application No. 63/141,301, filed on Jan. 25, 2021.
(60) Provisional application No. 63/187,841, filed on May 12, 2021.

(51) Int. Cl. G06Q 40/08; G06Q 30/02

(52) U.S. Cl. CPC G06Q 40/08; G06Q 30/0201

(57) ABSTRACT

A computer-implemented method, computer program product and computing system for obtaining an underwriting model from each of a plurality of insurance providers, resulting in a plurality of underwriting models; generating a dynamic underwriting model based, at least in part, upon the plurality of underwriting models; receiving a request for an insurance quote; requesting applicant information based, at least in part, upon the dynamic underwriting model, thus defining dynamic applicant information; and providing at least a portion of the dynamic applicant information to each of the plurality of insurance providers for the purpose of generating the insurance quote.

### RELATED APPLICATION(S)

This application claims the benefit of U.S. Provisional Application Nos.: 63/081,730 filed on 22 Sep. 2020, 63/141,301 filed on 25 Jan. 2021, and 63/187,841 filed on 12 May 2021, the entire contents of which are incorporated herein by reference.

### TECHNICAL FIELD

This disclosure relates to evaluation response systems and methods and, more particularly, to evaluation response systems and methods for use in processing applications.

### BACKGROUND

In the modern computer age, people may utilize their computers and network connectivity to obtain quotes and estimates for various goods and services. For example, people may configure a car online to determine its purchase price, people may request an estimate for a bathroom remodel, or fill out a questionnaire to obtain an insurance estimate.

Unfortunately, in the event that a user wants to obtain competitive bids/estimates for the same good/service, the user would be required to submit the same or similar pieces of information via multiple websites/portals. As could be imagined, this could prove to be a complex and time consuming task if the user wishes to obtain an estimate from a considerable number of providers of good/services.

### SUMMARY OF DISCLOSURE

Insurance-Focus

In one implementation, a computer-implemented method is executed on a computing device and includes: obtaining an underwriting model from each of a plurality of insurance providers, resulting in a plurality of underwriting models; generating a dynamic underwriting model based, at least in part, upon the plurality of underwriting models; receiving a request for an insurance quote; requesting applicant information based, at least in part, upon the dynamic underwriting model, thus defining dynamic applicant information; and providing at least a portion of the dynamic applicant information to each of the plurality of insurance providers for the purpose of generating the insurance quote.

One or more of the following features may be included. The insurance quote may be a business/commercial insurance quote. The plurality of insurance providers may be a plurality of business/commercial insurance providers. The insurance quote may be a business/commercial insurance quote. The dynamic underwriting model may include a plurality of dynamically-defined information inquiries. The dynamic applicant information may include responses to the plurality of dynamically-defined information inquiries. Each of the plurality of underwriting models may include a plurality of information inquiries. Generating a dynamic underwriting model may include: processing the plurality of underwriting models to remove redundant information inquiries defined within the plurality of underwriting models. Generating a dynamic underwriting model may include: mapping one or more information inquiries within each of the plurality of underwriting models to one or more information inquiries within the dynamic underwriting model. Receiving a request for an evaluation response may include: receiving the request for the evaluation response from a user. Receiving a request for an evaluation response may include: receiving the request for the evaluation response from a remote computing device. The insurance quote may be received from one or more of the plurality of insurance providers, wherein the insurance quote may be based, at least in part, upon the at least a portion of the dynamic applicant information.

In another implementation, a computer program product resides on a computer readable medium and has a plurality of instructions stored on it. When executed by a processor, the instructions cause the processor to perform operations including obtaining an underwriting model from each of a plurality of insurance providers, resulting in a plurality of underwriting models; generating a dynamic underwriting model based, at least in part, upon the plurality of underwriting models; receiving a request for an insurance quote; requesting applicant information based, at least in part, upon the dynamic underwriting model, thus defining dynamic applicant information; and providing at least a portion of the dynamic applicant information to each of the plurality of insurance providers for the purpose of generating the insurance quote.

One or more of the following features may be included. The insurance quote may be a business/commercial insurance quote. The plurality of insurance providers may be a plurality of business/commercial insurance providers. The insurance quote may be a business/commercial insurance quote. The dynamic underwriting model may include a plurality of dynamically-defined information inquiries. The dynamic applicant information may include responses to the plurality of dynamically-defined information inquiries. Each of the plurality of underwriting models may include a plurality of information inquiries. Generating a dynamic underwriting model may include: processing the plurality of underwriting models to remove redundant information inquiries defined within the plurality of underwriting models. Generating a dynamic underwriting model may include: mapping one or more information inquiries within each of the plurality of underwriting models to one or more information inquiries within the dynamic underwriting model. Receiving a request for an evaluation response may include: receiving the request for the evaluation response from a user. Receiving a request for an evaluation response may include: receiving the request for the evaluation response from a remote computing device. The insurance quote may be received from one or more of the plurality of insurance providers, wherein the insurance quote may be based, at least in part, upon the at least a portion of the dynamic applicant information.

In another implementation, a computing system includes a processor and a memory system configured to perform operations including obtaining an underwriting model from each of a plurality of insurance providers, resulting in a plurality of underwriting models; generating a dynamic underwriting model based, at least in part, upon the plurality of underwriting models; receiving a request for an insurance quote; requesting applicant information based, at least in part, upon the dynamic underwriting model, thus defining dynamic applicant information; and providing at least a portion of the dynamic applicant information to each of the plurality of insurance providers for the purpose of generating the insurance quote.

One or more of the following features may be included. The insurance quote may be a business/commercial insurance quote. The plurality of insurance providers may be a plurality of business/commercial insurance providers. The insurance quote may be a business/commercial insurance quote. The dynamic underwriting model may include a plurality of dynamically-defined information inquiries. The dynamic applicant information may include responses to the plurality of dynamically-defined information inquiries. Each of the plurality of underwriting models may include a plurality of information inquiries. Generating a dynamic underwriting model may include: processing the plurality of underwriting models to remove redundant information inquiries defined within the plurality of underwriting models. Generating a dynamic underwriting model may include: mapping one or more information inquiries within each of the plurality of underwriting models to one or more information inquiries within the dynamic underwriting model. Receiving a request for an evaluation response may include: receiving the request for the evaluation response from a user. Receiving a request for an evaluation response may include: receiving the request for the evaluation response from a remote computing device. The insurance quote may be received from one or more of the plurality of insurance providers, wherein the insurance quote may be based, at least in part, upon the at least a portion of the dynamic applicant information.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a distributed computing network including a computing device that executes an evaluation response process according to an embodiment of the present disclosure;

FIG. 2 is a diagrammatic view of a network of providers accessible by the evaluation response process of FIG. 1 according to an embodiment of the present disclosure;

FIG. 3 is a flowchart of the evaluation response process of FIG. 1 according to an embodiment of the present disclosure;

FIG. 4 is a diagrammatic view of a classification hypertree utilized by the evaluation response process of FIG. 1 according to an embodiment of the present disclosure; and

FIG. 5 is another flowchart of the evaluation response process of FIG. 1 according to an embodiment of the present disclosure.

Like reference symbols in the various drawings indicate like elements.

### DETAILED DESCRIPTION OF THE PREFERRED EMBODIMENTS

System Overview

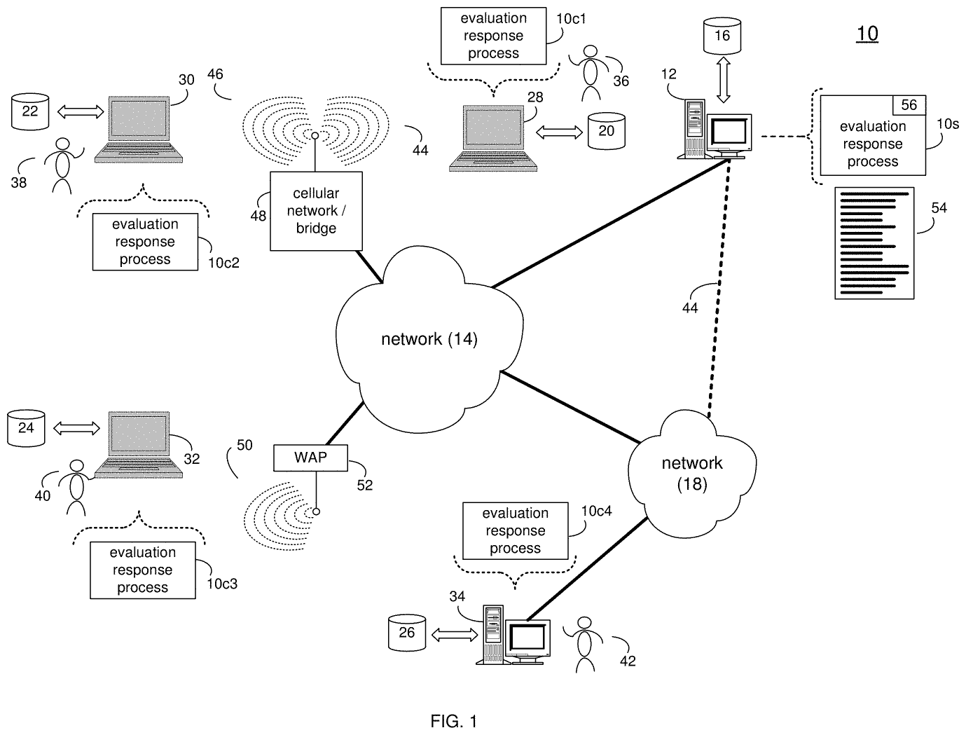

Referring to FIG. 1, there is shown evaluation response process 10. Evaluation response process 10 may be implemented as a server-side process, a client-side process, or a hybrid server-side/client-side process. For example, evaluation response process 10 may be implemented as a purely server-side process via evaluation response process 10s. Alternatively, evaluation response process 10 may be implemented as a purely client-side process via one or more of evaluation response process 10c1, evaluation response process 10c2, evaluation response process 10c3, and evaluation response process 10c4. Alternatively still, evaluation response process 10 may be implemented as a hybrid server-side/client-side process via evaluation response process 10s in combination with one or more of evaluation response process 10c1, evaluation response process 10c2, evaluation response process 10c3, and evaluation response process 10c4. Accordingly, evaluation response process 10 as used in this disclosure may include any combination of evaluation response process 10s, evaluation response process 10c1, evaluation response process 10c2, evaluation response process 10c3, and evaluation response process 10c4.

Evaluation response process 10s may be a server application and may reside on and may be executed by computing device 12, which may be connected to network 14 (e.g., the Internet or a local area network). Examples of computing device 12 may include, but are not limited to: a personal computer, a server computer, a series of server computers, a mini computer, a mainframe computer, a smartphone, or a cloud-based computing platform.

The instruction sets and subroutines of evaluation response process 10s, which may be stored on storage device 16 coupled to computing device 12, may be executed by one or more processors (not shown) and one or more memory architectures (not shown) included within computing device 12. Examples of storage device 16 may include but are not limited to: a hard disk drive; a RAID device; a random access memory (RAM); a read-only memory (ROM); and all forms of flash memory storage devices.

Network 14 may be connected to one or more secondary networks (e.g., network 18), examples of which may include but are not limited to: a local area network; a wide area network; or an intranet, for example.

Examples of evaluation response processes 10c1, 10c2, 10c3, 10c4 may include but are not limited to a web browser, a game console user interface, a mobile device user interface, or a specialized application (e.g., an application running on e.g., the Android™ platform, the iOS™ platform, the Windows™ platform, the Linux™ platform or the UNIX platform). The instruction sets and subroutines of evaluation response processes 10c1, 10c2, 10c3, 10c4, which may be stored on storage devices 20, 22, 24, 26 (respectively) coupled to client electronic devices 28, 30, 32, 34 (respectively), may be executed by one or more processors (not shown) and one or more memory architectures (not shown) incorporated into client electronic devices 28, 30, 32, 34 (respectively). Examples of storage devices 20, 22, 24, 26 may include but are not limited to: hard disk drives; RAID devices; random access memories (RAM); read-only memories (ROM), and all forms of flash memory storage devices.

Examples of client electronic devices 28, 30, 32, 34 may include, but are not limited to, a smartphone (not shown), a personal digital assistant (not shown), a tablet computer (not shown), laptop computers 28, 30, 32, personal computer 34, a notebook computer (not shown), a server computer (not shown), a gaming console (not shown), and a dedicated network device (not shown). Client electronic devices 28, 30, 32, 34 may each execute an operating system, examples of which may include but are not limited to Microsoft Windows™, Android™, iOS™, Linux™, or a custom operating system.

Users 36, 38, 40, 42 may access evaluation response process 10 directly through network 14 or through secondary network 18. Further, evaluation response process 10 may be connected to network 14 through secondary network 18, as illustrated with link line 44.

The various client electronic devices (e.g., client electronic devices 28, 30, 32, 34) may be directly or indirectly coupled to network 14 (or network 18). For example, laptop computer 28 and laptop computer 30 are shown wirelessly coupled to network 14 via wireless communication channels 44, 46 (respectively) established between laptop computers 28, 30 (respectively) and cellular network/bridge 48, which is shown directly coupled to network 14. Further, laptop computer 32 is shown wirelessly coupled to network 14 via wireless communication channel 50 established between laptop computer 32 and wireless access point (i.e., WAP) 52, which is shown directly coupled to network 14. Additionally, personal computer 34 is shown directly coupled to network 18 via a hardwired network connection.

WAP 52 may be, for example, an IEEE 802.11a, 802.11b, 802.11g, 802.11n, Wi-Fi, and/or Bluetooth device that is capable of establishing wireless communication channel 50 between laptop computer 32 and WAP 52. As is known in the art, IEEE 802.11x specifications may use Ethernet protocol and carrier sense multiple access with collision avoidance (i.e., CSMA/CA) for path sharing. As is known in the art, Bluetooth is a telecommunications industry specification that allows e.g., mobile phones, computers, and personal digital assistants to be interconnected using a short-range wireless connection.

Traditional Submission to Providers (Overview)

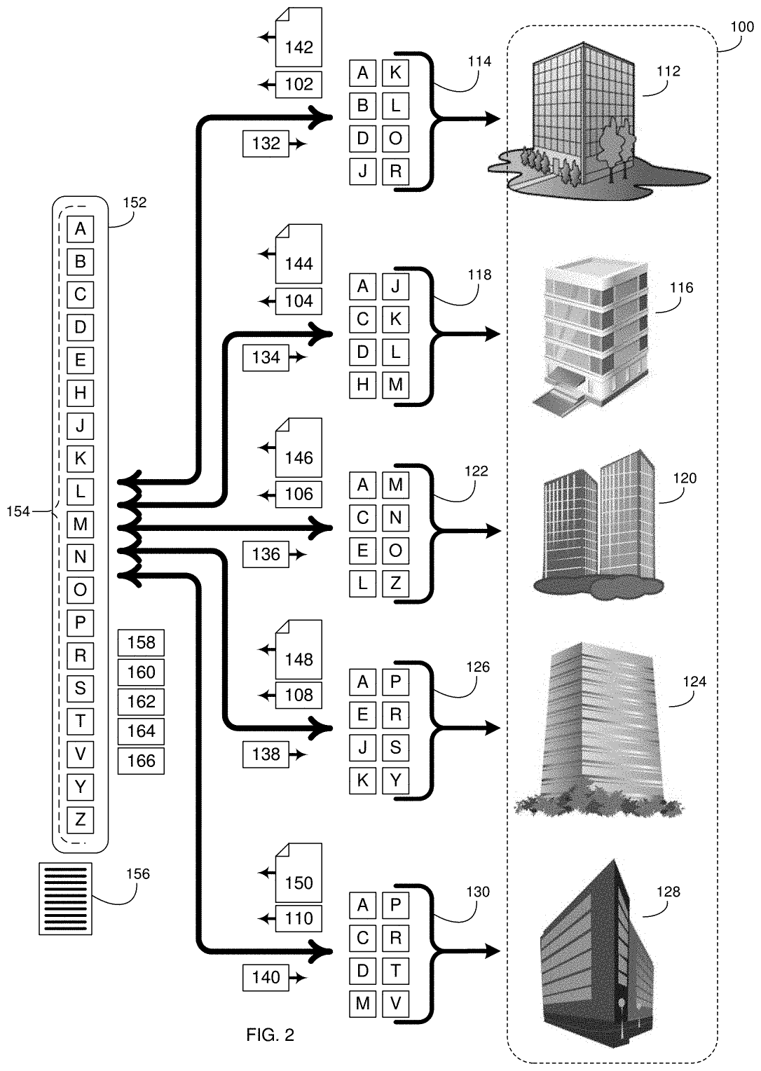

Referring also to FIG. 2 and as will be discussed below in greater detail, various companies/entities (collectively referred to as plurality of providers 100) may provide goods/services to people/entities. Plurality of providers 100 may include any type of provider, examples of which may include but are not limited to:
a plurality of loan providers (e.g., commercial banks, credit unions, credit card companies, investors, venture capitalists, financier, trust manager, fund manager, charity manager, etc.);
a plurality of funding providers (e.g., commercial banks, credit unions, credit card companies, investors, venture capitalists, financier, trust manager, fund manager, charity manager, etc.);
a plurality of credit providers (e.g., commercial banks, credit unions, credit card companies, investors, venture capitalists, financier, trust manager, fund manager, charity manager, etc.);
a plurality of grant providers (e.g., commercial banks, credit unions, credit card companies, investors, venture capitalists, financier, trust manager, fund manager, charity manager, etc.);
a plurality of education providers (e.g., colleges, universities, trade schools, graduate schools, law schools, medical schools, continuing education facilities, etc.);
a plurality of rental providers (e.g., apartment complexes, condo complexes, co-op complexes, leasing companies, time-share companies, rent-to-own companies, rental companies, etc.);
a plurality of mortgage providers (e.g., commercial banks, credit unions, mortgage companies, etc.);
a plurality of employment providers (e.g., private employers, state employers, federal employers, international employers, non-profit employers, charitable employers, etc.); and
a plurality of insurance providers (e.g., auto insurance companies, business/commercial insurance companies, property and casualty insurance companies, medical insurance companies, homeowner insurance companies, life insurance companies, renter insurance companies, etc.).

When a user (e.g., user 36) is considering purchasing goods/services from one or more of plurality of providers 100, the user (e.g., user 36) may submit a request for an evaluation response (e.g., request 54) to one or more of plurality of providers 100. For example, assume that the user (e.g., user 36) is interested in e.g., applying for a loan, applying for funding, applying for credit, applying for a grant, applying for a rental, applying for a mortgage, applying for employment, and/or applying for insurance. Accordingly, the user (e.g., user 36) may submit a request for an evaluation response (e.g., request 54) to the plurality of providers 100 so that one or more of the plurality of providers 100 may provide an evaluation response (e.g., quotes/estimates/approvals 102, 104, 106, 108, 110). Examples of this request for an evaluation response (e.g., request 54) may include but is not limited to: a loan application; a funding application; a credit application; a grant application; an educational institution application; a rental application; a mortgage application; an employment application; and an insurance application.

As could be imagined, when e.g., applying for a loan, applying for funding, applying for credit, applying for a grant, applying for a rental, applying for a mortgage, applying for employment, and/or applying for insurance with plurality of providers 100, each of the plurality of providers 100 may require different pieces of information in order to generate an evaluation response (e.g., quotes/estimates/approvals 102, 104, 106, 108, 110). Examples of such pieces of information may include but are not limited to: first name, middle name, last name, home address, business address, age, gender, employment history, educational history, rental history, social security number, annual income, business type, known languages, skillsets, etc.

For example:
provider 112 (of plurality of providers 100) may require pieces of information 114 (e.g., A, B, D, J, K, L, O, R) in order to generate quote/estimate/approval 102;
provider 116 (of plurality of providers 100) may require pieces of information 118 (e.g., A, C, D, H, J, K, L, M) in order to generate quote/estimate/approval 104;
provider 120 (of plurality of providers 100) may require pieces of information 122 (e.g., A, C, E, L, M, N, O, Z) in order to generate quote/estimate/approval 106;
provider 124 (of plurality of providers 100) may require pieces of information 126 (e.g., A, E, J, K, P, R, S, Y) in order to generate quote/estimate/approval 108; and
provider 128 (of plurality of providers 100) may require pieces of information 130 (e.g., A, C, D, M, P, R, T, V) in order to generate quote/estimate/approval 110.

While in this particular example, plurality of providers 100 is shown to include five providers (e.g., providers 112, 116, 120, 124, 128), this is for illustrative purposes only and is not intended to be a limitation of this disclosure, as it is understood that plurality of providers 100 may include 10s, 100s, or 1000s of discrete providers.

Since (in this example) each of plurality of providers 100 is shown to require slightly different pieces of information in order to generate an evaluation response (e.g., quotes/estimates/approvals 102, 104, 106, 108, 110), in the event that the user (e.g., user 36) wishes to obtain an evaluation response from each of e.g., providers 112, 116, 120, 124, 128, the user (e.g., user 36) would unfortunately need to submit a separate request for an evaluation response (e.g., request 54) to each of (in this example) the five providers (e.g., providers 112, 116, 120, 124, 128). Further, the user (e.g., user 36) may be required to redundantly submit the same information to multiple providers (e.g., piece of information A is shown to be required by all of providers 112, 116, 120, 124, 128).

For example, the user (e.g., user 36) may be required to:
submit request 132 to provider 112 (of plurality of providers 100) that includes pieces of information 114 (e.g., A, B, D, J, K, L, O, R) in order to generate quote/estimate/approval 102;
submit request 134 to provider 116 (of plurality of providers 100) that includes pieces of information 118 (e.g., A, C, D, H, J, K, L, M) in order to generate quote/estimate/approval 104;
submit request 136 to provider 120 (of plurality of providers 100) that includes pieces of information 122 (e.g., A, C, E, L, M, N, O, Z) in order to generate quote/estimate/approval 106;
submit request 138 to provider 124 (of plurality of providers 100) that includes pieces of information 126 (e.g., A, E, J, K, P, R, S, Y) in order to generate quote/estimate/approval 108; and
submit request 140 to provider 128 (of plurality of providers 100) that includes pieces of information 130 (e.g., A, C, D, M, P, R, T, V) in order to generate quote/estimate/approval 110.

Accordingly and concerning such redundant submissions of information, the user (e.g., user 36) would be required to provide:
Information A five times (i.e., to providers 112, 116, 120, 124, 128);
Information C three times (i.e., to providers 116, 120, 128);
Information D three times (i.e., to providers 112, 116, 128);
Information E two times (i.e., to providers 120, 124);
Information J three times (i.e., to providers 112, 116, 124);
Information K three times (i.e., to providers 112, 116, 124);
Information L three times (i.e., to providers 112, 116, 120);
Information M three times (i.e., to providers 116, 120, 128);
Information O two times (i.e., to providers 112, 120);
Information P two times (i.e., to providers 124, 128); and
Information R three times (i.e., to providers 112, 124, 128).

As will be discussed below in greater detail, in order to avoid such redundant and repetitious submission of information, evaluation response process 10 may be configured to streamline this information entry task and allow for a consolidated information submission process that only requires the user (e.g., user 36) to submit a single request for an evaluation response (e.g., request 54) that is processed and provided (in whole or in part) to e.g., each of providers 112, 116, 120, 124, 128.

Evaluation Response Process (General)

As discussed above, providers 112, 116, 120, 124, 128 may require slightly different pieces of information (e.g., pieces of information 114, 118, 122, 126, 130) in order to generate an evaluation response (e.g., quote/estimate/approval 102, 104, 106, 108, 110 respectively). Therefore and in order to expedite and simplify the generation of evaluation responses (e.g., quote/estimate/approval 102, 104, 106, 108, 110), evaluation response process 10 may first determine what pieces of information are required by each of (in this example) providers 112, 116, 120, 124, 128.

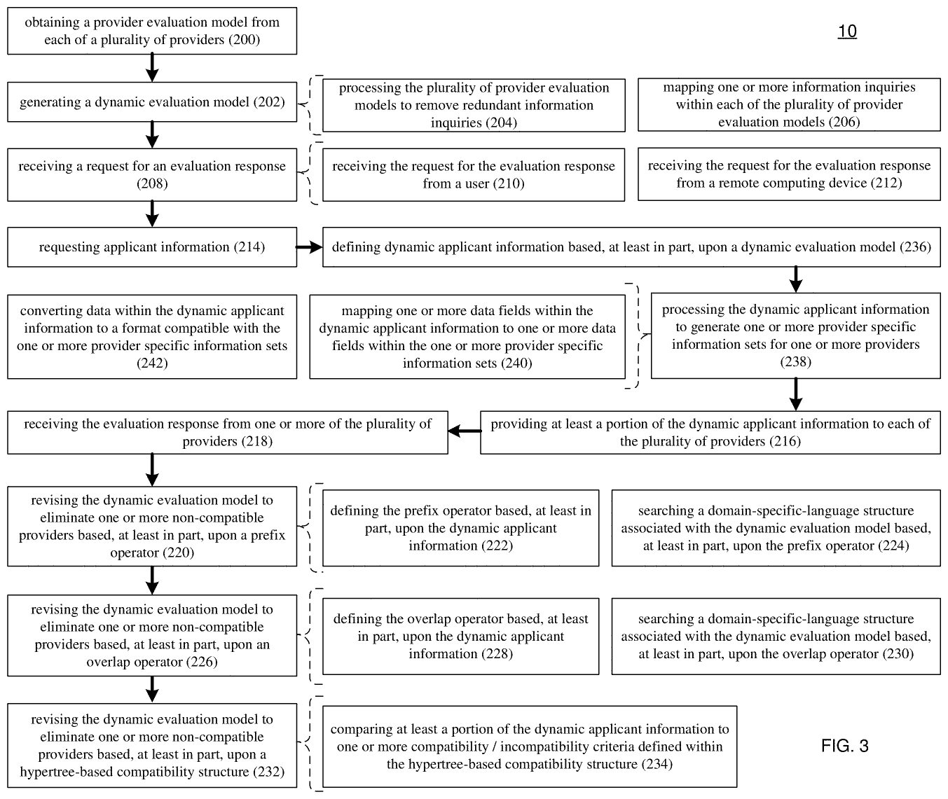

Accordingly and referring also to FIG. 3, evaluation response process 10 may obtain 200 a provider evaluation model from each of a plurality of providers (e.g., providers 112, 116, 120, 124, 128), resulting in a plurality of provider evaluation models (e.g., provider evaluation models 142, 144, 146, 148, 150 respectively). Each of the plurality of provider evaluation models (e.g., provider evaluation models 142, 144, 146, 148, 150) may include a plurality of information inquiries (e.g., information inquiries for pieces of information 114, 118, 122, 126, 130 respectively). For example, the plurality of provider evaluation models (e.g., provider evaluation models 142, 144, 146, 148, 150) may define the questions that need to be answered in order for providers 112, 116, 120, 124, 128 (respectively) to provide an evaluation response (e.g., quotes/estimates/approvals 102, 104, 106, 108, 110 respectively).

For example:
provider evaluation model 142 may define the information inquiries (e.g., the questions) that need to be answered to obtain pieces of information 114 required for provider 112 to provide quote/estimate/approval 102;
provider evaluation model 144 may define information inquiries (e.g., the questions) that need to be answered to obtain pieces of information 118 required for provider 116 to provide quote/estimate/approval 104;
provider evaluation model 146 may define information inquiries (e.g., the questions) that need to be answered to obtain pieces of information 122 required for provider 120 to provide quote/estimate/approval 106;
provider evaluation model 148 may define information inquiries (e.g., the questions) that need to be answered to obtain pieces of information 126 required for provider 124 to provide quote/estimate/approval 108; and
provider evaluation model 150 may define information inquiries (e.g., the questions) that need to be answered to obtain pieces of information 130 required for provider 128 to provide quote/estimate/approval 110.

As discussed above, the plurality of providers (e.g., plurality of providers 100) may include one or more of: a plurality of loan providers; a plurality of funding providers; a plurality of credit providers; a plurality of grant providers; a plurality of education providers; a plurality of rental providers; a plurality of mortgage providers; a plurality of employment providers; and a plurality of insurance providers.

Once the provider evaluation models (e.g., provider evaluation models 142, 144, 146, 148, 150 are obtained 200, evaluation response process 10 may generate 202 a dynamic evaluation model (e.g., dynamic evaluation model 152) based, at least in part, upon the plurality of provider evaluation models (e.g., provider evaluation models 142, 144, 146, 148, 150). The dynamic evaluation model (e.g., dynamic evaluation model 152) may include a plurality of dynamically-defined information inquiries (e.g., dynamically-defined information inquiries 154).

As will be discussed below in greater detail, when generating 202 a dynamic evaluation model (e.g., dynamic evaluation model 152), evaluation response process 10 may:
process 204 the plurality of provider evaluation models (e.g., provider evaluation models 142, 144, 146, 148, 150) to remove redundant information inquiries defined within the plurality of provider evaluation models (e.g., provider evaluation models 142, 144, 146, 148, 150); and/or
map 206 one or more information inquiries within each of the plurality of provider evaluation models (e.g., provider evaluation models 142, 144, 146, 148, 150) to one or more information inquiries within the dynamic evaluation model (e.g., dynamic evaluation model 152).

As discussed above:
provider 112 (of plurality of providers 100) may require pieces of information 114 (e.g., A, B, D, J, K, L, O, R) in order to generate quote/estimate/approval 102;
provider 116 (of plurality of providers 100) may require pieces of information 118 (e.g., A, C, D, H, J, K, L, M) in order to generate quote/estimate/approval 104;
provider 120 (of plurality of providers 100) may require pieces of information 122 (e.g., A, C, E, L, M, N, O, Z) in order to generate quote/estimate/approval 106;
provider 124 (of plurality of providers 100) may require pieces of information 126 (e.g., A, E, J, K, P, R, S, Y) in order to generate quote/estimate/approval 108; and
provider 128 (of plurality of providers 100) may require pieces of information 130 (e.g., A, C, D, M, P, R, T, V) in order to generate quote/estimate/approval 110.

Accordingly, there is considerable redundancy/overlap with respect to the pieces of information required by providers 112, 116, 120, 124, 128. Specifically and concerning such redundant submissions of information, the user (e.g., user 36) would be required to provide:
Information A five times (i.e., to providers 112, 116, 120, 124, 128);
Information C three times (i.e., to providers 116, 120, 128);
Information D three times (i.e., to providers 112, 116, 128);
Information E two times (i.e., to providers 120, 124);
Information J three times (i.e., to providers 112, 116, 124);
Information K three times (i.e., to providers 112, 116, 124);
Information L three times (i.e., to providers 112, 116, 120);
Information M three times (i.e., to providers 116, 120, 128);
Information O two times (i.e., to providers 112, 120);
Information P two times (i.e., to providers 124, 128); and
Information R three times (i.e., to providers 112, 124, 128).

Accordingly and when generating 202 dynamic evaluation model 152, evaluation response process 10 may process 204 the plurality of provider evaluation models (e.g., provider evaluation models 142, 144, 146, 148, 150) to remove redundant information inquiries defined within the plurality of provider evaluation models (e.g., provider evaluation models 142, 144, 146, 148, 150).

Therefore and once processed 204, dynamic evaluation model 152 may include only one instance of each information inquiry, resulting in dynamic evaluation model 152 including information inquiries: A, B, C, D, E, H, J, K, L, M, N, O, P, R, S, T, V, Y, Z. Accordingly, dynamic evaluation model 152 includes (in this example) nineteen unique information inquiries, which is substantially less than the total of forty redundant/overlapping information inquiries required by providers 112, 116, 120, 124, 128 and defined within provider evaluation models 142, 144, 146, 148, 150 (respectively).

Additionally and when generating 202 dynamic evaluation model 152, evaluation response process 10 may map 206 information inquiries within each of the plurality of provider evaluation models (e.g., provider evaluation models 142, 144, 146, 148, 150) to information inquiries within the dynamic evaluation model (e.g., dynamic evaluation model 152).

Therefore and once completely processed:
Information Inquiry A may be mapped 206 to provider evaluation models 142, 144, 146, 148, 150;
Information Inquiry B may be mapped 206 to provider evaluation model 142;
Information Inquiry C may be mapped 206 to provider evaluation models 144, 146, 150;
Information Inquiry D may be mapped 206 to provider evaluation models 142, 144, 150;
Information Inquiry E may be mapped 206 to provider evaluation models 146, 148;
Information Inquiry H may be mapped 206 to provider evaluation model 144;
Information Inquiry J may be mapped 206 to provider evaluation models 142, 144, 148;
Information Inquiry K may be mapped 206 to provider evaluation models 142, 144, 148;
Information Inquiry L may be mapped 206 to provider evaluation models 142, 144, 146;
Information Inquiry M may be mapped 206 to provider evaluation models 144, 146, 150;
Information Inquiry N may be mapped 206 to provider evaluation model 146;
Information Inquiry O may be mapped 206 to provider evaluation models 142, 146;
Information Inquiry P may be mapped 206 to provider evaluation models 148, 150;
Information Inquiry R may be mapped 206 to provider evaluation models 142, 148, 150;
Information Inquiry S may be mapped 206 to provider evaluation model 148;
Information Inquiry T may be mapped 206 to provider evaluation model 150;
Information Inquiry V may be mapped 206 to provider evaluation model 150;
Information Inquiry Y may be mapped 206 to provider evaluation model 148; and
Information Inquiry Z may be mapped 206 to provider evaluation model 146.

These mappings may be one-to-one, one-to-many, and/or many-to-one. For example and in a one-to-one mapping, a first name information inquiry may be mapped to a first name information inquiry. Further and in a one-to-many mapping, a full name information inquiry may be mapped to a first name information inquiry and a last name information inquiry. Additionally and in a many-to-one mapping, a first name information inquiry and a last name information inquiry may be mapped to a full name information inquiry.

In the event that additional providers (not shown) come online in the future, evaluation response process 10 may update dynamic evaluation model 152 by e.g., obtaining a provider evaluation model (not shown) from each of these additional providers, and using the information inquiries (not shown) included within these additional provider evaluation models (not shown) to update dynamic evaluation model 152.

Once dynamic evaluation model 152 is generated 202, evaluation response process 10 may utilize dynamic evaluation model 152 to streamline the information entry process by eliminating redundancy and allowing for a consolidated information submission process that only requires the submission of a single request for an evaluation response (e.g., request 54) that is processed and provided (in whole or in part) to e.g., each of providers 112, 116, 120, 124, 128.

Assume for the following example that the user (e.g., user 36) wishes to receive an evaluation response (e.g., quote/estimate/approval 102, 104, 106, 108, 110) from each of providers 112, 116, 120, 124, 128. Accordingly, the user (e.g., user 36) may initiate the process by generating request 54, wherein request 54 (i.e., a request for an evaluation response) may be received 208 by evaluation response process 10. As discussed above, this request for an evaluation response (e.g., request 54) may include one or more of: a loan application; a funding application; a credit application; a grant application; an educational institution application; a rental application; a mortgage application; an employment application; and an insurance application.

As discussed above, when receiving 208 a request for an evaluation response (e.g., request 54), evaluation response process 10 may receive 210 the request for the evaluation response (e.g., request 54) from a user (e.g., user 36). However, other configurations are possible and are considered to be within the scope of this disclosure. For example and when receiving 208 a request for an evaluation response (e.g., request 54), evaluation response process 10 may receive 212 the request for the evaluation response (e.g., request 54) from a remote computing device. For example, a centralized computing system (not shown) associated with an insurance brokerage house (not shown) may be configured to interface with an API (e.g., API 56) of evaluation response process 10 exposed by computing device 12.

Once request 54 (i.e., the request for the evaluation response) is received 208 by evaluation response process 10, evaluation response process 10 may request 214 applicant information based, at least in part, upon the dynamic evaluation model (e.g., dynamic evaluation model 152), thus defining dynamic applicant information (e.g., dynamic applicant information 156). This dynamic applicant information (e.g., dynamic applicant information 156) may include responses to the plurality of dynamically-defined information inquiries (e.g., dynamically-defined information inquiries 154). For example, dynamic applicant information 156 may be responses to dynamically-defined information inquiries 154, wherein dynamic applicant information 156 may define e.g., first name, middle name, last name, home address, business address, age, gender, employment history, educational history, rental history, social security number, annual income, business type, known languages, skillsets, etc.

Evaluation response process 10 may provide 216 at least a portion of the dynamic applicant information (e.g., dynamic applicant information 156) to each of the plurality of providers (e.g., providers 112, 116, 120, 124, 128) for the purpose of generating the evaluation response (e.g., quotes/estimates/approvals 102, 104, 106, 108, 110).

Accordingly:
since provider 112 (of plurality of providers 100) requires pieces of information 114 (e.g., A, B, D, J, K, L, O, R) in order to generate quote/estimate/approval 102, evaluation response process 10 may provide 216 at least a portion of dynamic applicant information 156 (namely pieces of information A, B, D, J, K, L, O, R) to provider 112;
since provider 116 (of plurality of providers 100) requires pieces of information 118 (e.g., A, C, D, H, J, K, L, M) in order to generate quote/estimate/approval 104, evaluation response process 10 may provide 216 at least a portion of dynamic applicant information 156 (namely pieces of information A, C, D, H, J, K, L, M) to provider 116;
since provider 120 (of plurality of providers 100) requires pieces of information 122 (e.g., A, C, E, L, M, N, O, Z) in order to generate quote/estimate/approval 106, evaluation response process 10 may provide 216 at least a portion of dynamic applicant information 156 (namely pieces of information A, C, E, L, M, N, O, Z) to provider 120;
since provider 124 (of plurality of providers 100) requires pieces of information 126 (e.g., A, E, J, K, P, R, S, Y) in order to generate quote/estimate/approval 108, evaluation response process 10 may provide 216 at least a portion of dynamic applicant information 156 (namely pieces of information A, E, J, K, P, R, S, Y) to provider 124; and
since provider 128 (of plurality of providers 100) requires pieces of information 130 (e.g., A, C, D, M, P, R, T, V) in order to generate quote/estimate/approval 110, evaluation response process 10 may provide 216 at least a portion of dynamic applicant information 156 (namely pieces of information A, C, D, M, P, R, T, V) to provider 128.

Once the required pieces of information are received, providers 112, 116, 120, 124, 128 may process this information and generate quotes/estimates/approvals 102, 104, 106, 108, 110. Evaluation response process 10 may receive 218 these evaluation responses (e.g., one or more of quotes/estimates/approvals 102, 104, 106, 108, 110) from one or more of the plurality of providers (e.g., providers 112, 116, 120, 124, 128), wherein these evaluation responses (e.g., one or more of quotes/estimates/approvals 102, 104, 106, 108, 110) may be based, at least in part, upon at least a portion of the dynamic applicant information (e.g., dynamic applicant information 156).

Accordingly:
quote/estimate/approval 102 may be based, at least in part, upon pieces of information 114 (e.g., A, B, D, J, K, L, O, R);
quote/estimate/approval 104 may be based, at least in part, upon pieces of information 118 (e.g., A, C, D, H, J, K, L, M);
quote/estimate/approval 106 may be based, at least in part, upon pieces of information 122 (e.g., A, C, E, L, M, N, O, Z);
quote/estimate/approval 108 may be based, at least in part, upon pieces of information 126 (e.g., A, E, J, K, P, R, S, Y); and
quote/estimate/approval 110 may be based, at least in part, upon pieces of information 130 (e.g., A, C, D, M, P, R, T, V).

Once received 218, evaluation response process 10 may provide these evaluation responses (e.g., one or more of quotes/estimates/approvals 102, 104, 106, 108, 110) to the requester (e.g., the user or another computer), wherein these responses (e.g., one or more of quotes/estimates/approvals 102, 104, 106, 108, 110) may be provided in their raw form (as received from the provider) or may be homogenized/consolidated to form a report.

Domain Specific Language

As is known in the art, a domain-specific language (DSL) is a computer language specialized to a particular application domain, which is in contrast to a general-purpose language (GPL) that is broadly applicable across domains. There are a wide variety of domain-specific languages, ranging from widely used languages for common domains (e.g., HTML for web pages) to languages used by only one piece (or a few pieces) of software (e.g., MUSH soft code). Domain-specific languages may be further subdivided based upon the type of language, such as domain-specific markup languages, domain-specific modeling languages, and domain-specific programming languages.

Evaluation response process 10 may utilize such a domain-specific language to define navigational pathways through the dynamic evaluation model (e.g., dynamic evaluation model 152) generally and dynamically-defined information inquiries 154 (e.g., information inquiries for pieces of information A, B, C, D, E, H, J, K, L, M, N, O, P, R, S, T, V, Y, Z) specifically.

Since the quantity of these informational inquiries may number in the 1000s, not all of these informational inquiries need to be asked of every user (e.g., user 36). For example, if the user (e.g., user 36) is a business owner that is seeking insurance coverage for their retail business in Boston, Mass., it would make no sense to ask this user (e.g., user 36) informational inquiries that are unique to an insurance company that only provides business/commercial insurance for businesses located in the Pacific Northwest of the United States. Accordingly and through the use of such domain-specific language, evaluation response process 10 may navigate the user (e.g., user 36) through a pathway of informational inquiries that are specific to the user (e.g., user 36) and/or a profile of the user (e.g., user 36) and/or is based upon questions previously-answered by the user (e.g., user 36). For example, if the question “In what state are you located?” was asked of user 36, and user 36 responded with “Massachusetts”, any and all information inquiries unique to Pacific Northwest Insurance Company (which only ensures businesses in the Pacific Northwest of the United States) would be skipped to avoid asking questions that need not be answered.

In order to define an efficient pathway through the information inquiries without requiring the answering of redundant questions, evaluation response process 10 may utilize a customized domain-specific language that expands the set of commonly-known operators (e.g., AND, OR, NOT, LT, GT) to include custom PREFIX operators and OVERLAP operators (as will be discussed below in greater detail).

Evaluation Response Process (Prefix Operator)

As discussed above, evaluation response process 10 may generate 202 a dynamic underwriting model (e.g., dynamic evaluation model 152) based, at least in part, upon the plurality of underwriting models (e.g., provider evaluation models 142, 144, 146, 148, 150), wherein evaluation response process 10 may request 214 applicant information based, at least in part, upon the dynamic underwriting model (e.g., dynamic evaluation model 152), thus defining dynamic applicant information (e.g., dynamic applicant information 156).

As will be discussed below in greater detail, evaluation response process 10 may revise 220 the dynamic evaluation model (e.g., dynamic evaluation model 152) to eliminate one or more non-compatible providers (e.g., one or more of providers 112, 116, 120, 124, 128) based, at least in part, upon a PREFIX operator. Generally speaking, the PREFIX operator may determine whether the second operand starts with the first operand and may be used to evaluate a hierarchy implied by a structure of a string.

When revising 220 the dynamic evaluation model (e.g., dynamic evaluation model 152) to eliminate one or more non-compatible providers (e.g., one or more of providers 112, 116, 120, 124, 128) based, at least in part, upon a PREFIX operator, evaluation response process 10 may define 222 the PREFIX operator based, at least in part, upon the dynamic applicant information (e.g., dynamic applicant information 156); and may search 224 a domain-specific-language structure (see below) associated with the dynamic evaluation model (e.g., dynamic evaluation model 152) based, at least in part, upon the PREFIX operator.

For example, a system of DSL codes may reflect parent-child relationships. Accordingly and for items “123”, “123-1”, “123-2”, & “123-1-1”;
“123” may be a parent;
“123-1” & “123-2” may be children of “123”; and
“123-1-1” may be a child of “123-1” and a grandchild of “123”.

In order to define a condition for all “123 codes” using traditional DSL operators, the traditional DSL code would be:

[“OR”, [“==”, “$answer” “123”], [“==”, “$answer” “123-1”],

[“==”, “$answer” “123-2”],[“==”, “$answer” “123-1-1”]]

Obviously, this line of code is rather verbose. Additionally, this line of code is generally fixed in nature, as it does not account for new children/grandchildren should they appear. Accordingly and by defining a condition for all “123 codes” using the PREFIX operator, this custom DSL code would be:
[“PREFIX”, “$answer”, “123”]

Obviously, this PREFIX operator line of code is much less verbose, operates in a fashion similar to a wildcard, and is generally flexible in nature (as it accounts for new children/grandchildren should they appear).

Evaluation Response Process (Overlap Operator)

As discussed above, evaluation response process 10 may generate 202 a dynamic underwriting model (e.g., dynamic evaluation model 152) based, at least in part, upon the plurality of underwriting models (e.g., provider evaluation models 142, 144, 146, 148, 150), wherein evaluation response process 10 may request 214 applicant information based, at least in part, upon the dynamic underwriting model (e.g., dynamic evaluation model 152), thus defining dynamic applicant information (e.g., dynamic applicant information 156).

As will be discussed below in greater detail, evaluation response process 10 may revise 226 the dynamic evaluation model (e.g., dynamic evaluation model 152) to eliminate one or more non-compatible providers (e.g., one or more of providers 112, 116, 120, 124, 128) based, at least in part, upon an OVERLAP operator. Generally speaking, the OVERLAP operator may determine whether any of the elements in the first operand match any of the elements in the second operand.

When revising 226 the dynamic evaluation model (e.g., dynamic evaluation model 152) to eliminate one or more non-compatible providers (e.g., one or more of providers 112, 116, 120, 124, 128) based, at least in part, upon an OVERLAP operator, evaluation response process 10 may define 228 the OVERLAP operator based, at least in part, upon the dynamic applicant information (e.g., dynamic applicant information 156); and may search 230 a domain-specific-language structure (see below) associated with the dynamic evaluation model (e.g., dynamic evaluation model 152) based, at least in part, upon the OVERLAP operator.

For example, the OVERLAP operator may be used to evaluate whether multiple questions have multiple answers. For example, assume that: Question 1 is “What does your business do at your primary location?”, Question 2 is “What does your business do at your secondary location?”, and the answers of interest are “Masonry” and “Welding”.

In order to define a condition using traditional DSL operators, the traditional DSL code would be:

[“OR”, [“==”, “$Q1” “Masonry”], [“==”, “$Q1” “Welding”],

[“==”, “$Q2” “Masonry”], [“==”,“$Q3” “Welding”]]

Obviously, this line of code is rather verbose and redundant. Accordingly and by defining such a condition using the OVERLAP operator, this custom DSL code would be:
[“OVERLAP”, [“$Q1”, “$Q2”], [“Masonry”, “Welding”]]

Obviously, this OVERLAP operator line of code is much less verbose and redundant.

Evaluation Response Process (Hypertree)

As discussed above, evaluation response process 10 may generate 202 a dynamic underwriting model (e.g., dynamic evaluation model 152) based, at least in part, upon the plurality of underwriting models (e.g., provider evaluation models 142, 144, 146, 148, 150), wherein evaluation response process 10 may request 214 applicant information based, at least in part, upon the dynamic underwriting model (e.g., dynamic evaluation model 152), thus defining dynamic applicant information (e.g., dynamic applicant information 156).

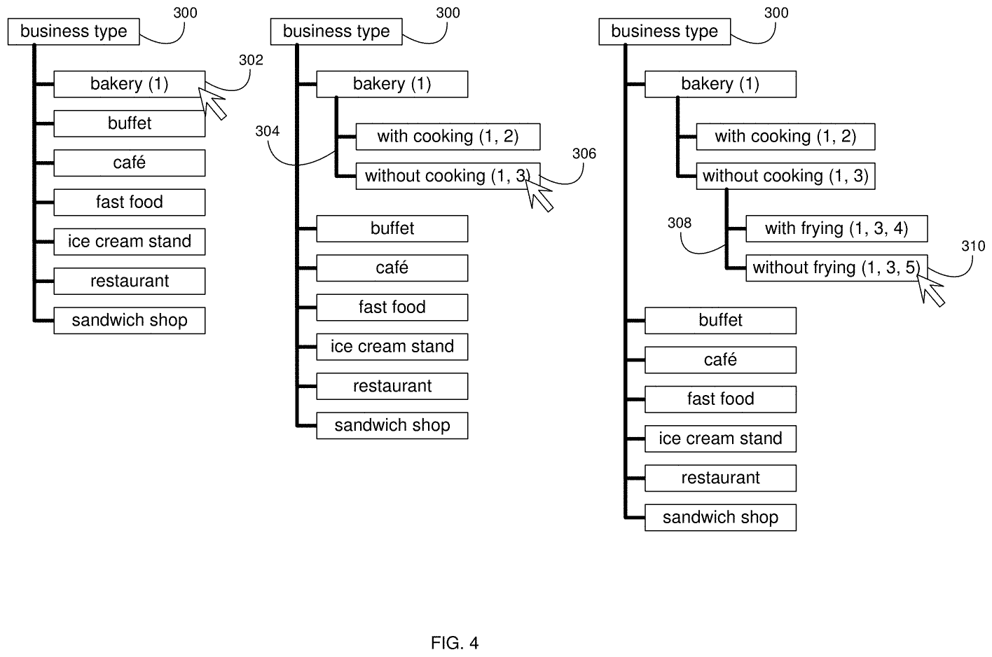

Referring also to FIG. 4 and as will be discussed below in greater detail, evaluation response process 10 may revise 232 the dynamic evaluation model (e.g., dynamic evaluation model 152) to eliminate one or more non-compatible providers (e.g., one or more of providers 112, 116, 120, 124, 128) based, at least in part, upon a hypertree-based compatibility structure (e.g., classification hypertree 300). Generally speaking, classification hypertree 300 may relate disparate business classification systems into one data structure, thus enabling carriers to be resolved at any depth.

As will be discussed below, classification hypertree 300 may allow disparate business classification systems to be cross-mapped and may allow for the resolution of conflicts by e.g., creating, splitting and/or nesting nodes. Classification hypertree 300 may also provide flexibility to achieve a desirable user experience by enabling the user (e.g., user 36) to self-identify what their business does. Depending upon how the user (e.g., user 36) identifies their business, classification hypertree 300 may determine which carriers are applicable (i.e., within scope) and/or which information inquiries within dynamic evaluation model 152 are applicable (i.e., within scope), thus maximizing compatible providers (e.g., one or more of providers 112, 116, 120, 124, 128) while eliminating non-applicable information inquiries defined within dynamic evaluation model 152.

For example and when revising 232 the dynamic evaluation model (e.g., dynamic evaluation model 152) to eliminate one or more non-compatible providers based, at least in part, upon a hypertree-based compatibility structure (e.g., classification hypertree 300), evaluation response process 10 may compare 234 at least a portion of the dynamic applicant information (e.g., dynamic applicant information 156) to one or more compatibility/incompatibility criteria defined within the hypertree-based compatibility structure (e.g., classification hypertree 300).

For example and via classification hypertree 300, the user (e.g., user 36) may provide dynamic applicant information 156 to evaluation response process 10 based, at least in part, upon the dynamic underwriting model (e.g., dynamic evaluation model 152). Assume that the user (e.g., user 36) wishes to receive one or more quotes (e.g., quotes/estimates/approvals 102, 104, 106, 108, 110) concerning business/commercial insurance for their company, which is a bakery that DOES NOT offer cooking and DOES NOT offer frying.

Accordingly, the user (e.g., user 36) may select option 302 (which is a bakery). Note that option 302 includes a parenthetical “1” that is intended in this example to illustrate that the first provider (e.g., provider 112) provides business/commercial insurance for all bakeries. Once selected, the user (e.g., user 36) may be presented with options 304, namely “with cooking” and “without cooking”. As the bakery of user 36 DOES NOT offer cooking, user 36 may select option 306 (which includes a parenthetical “1, 3”), indicating that the first provider (e.g., provider 112) and the third provider (e.g., provider 120) provide business/commercial insurance for bakeries without cooking. Once selected, the user (e.g., user 36) may be presented with options 308, namely “with frying” and “without frying”. As the bakery of user 36 DOES NOT offer frying, user 36 may select option 310 (which includes a parenthetical “1, 3, 5”), indicating that the first provider (e.g., provider 112), the third provider (e.g., provider 120) and fifth provider (e.g., provider 128) provide business/commercial insurance for a bakery that DOES NOT offer cooking and DOES NOT offer frying.

Without the data structure of classification hypertree 300, the user (e.g., user 36) would be required to identify their business across the disparate/confusing classification systems, resulting in inefficient and error-prone operation. During typical operation of classification hypertree 300, the above-described parentheticals may not be visible to the user (user 36) and are only referenced above to describe the underlying logic.

Evaluation Response Process (Payload Builder)

As discussed above, request 54 (i.e., the request for the evaluation response) may be received 208 by evaluation response process 10. And once received 208, evaluation response process 10 may define 236 dynamic applicant information (e.g., dynamic applicant information 156) based, at least in part, upon the dynamic evaluation model (e.g., dynamic evaluation model 152).

As discussed above, this dynamic evaluation model (e.g., dynamic evaluation model 152) may include a plurality of dynamically-defined information inquiries (e.g., dynamically-defined information inquiries 154) obtained from the provider evaluation models (e.g., provider evaluation models 142, 144, 146, 148, 150), wherein the dynamic applicant information (e.g., dynamic applicant information 156) may include responses to these dynamically-defined information inquiries. Dynamic evaluation model 152 may concern one or more of: a loan application; a funding application; a credit application; a grant application; an educational institution application; a rental application; a mortgage application; an employment application; and an insurance application, as dynamic evaluation model 152 is derived from (in this example) provider evaluation models 142, 144, 146, 148, 150,

As will be discussed below in greater detail, the process of defining 236 the dynamic applicant information (e.g., dynamic applicant information 156) may generally be referred to as building a payload that may be provided to each of the plurality of providers (e.g., providers 112, 116, 120, 124, 128) for the purpose of generating the evaluation responses (e.g., quotes/estimates/approvals 102, 104, 106, 108, 110). As discussed above, the plurality of providers (e.g., plurality of providers 100) may include one or more of: a plurality of loan providers; a plurality of funding providers; a plurality of credit providers; a plurality of grant providers; a plurality of education providers; a plurality of rental providers; a plurality of mortgage providers; a plurality of employment providers; and a plurality of insurance providers.

Specifically and as discussed above, when generating 202 dynamic evaluation model 152, evaluation response process 10 may:
process 204 the plurality of provider evaluation models (e.g., provider evaluation models 142, 144, 146, 148, 150) to remove redundant information inquiries defined within the plurality of provider evaluation models (e.g., provider evaluation models 142, 144, 146, 148, 150); and
map 206 one or more information inquiries within each of the plurality of provider evaluation models (e.g., provider evaluation models 142, 144, 146, 148, 150) to one or more information inquiries within the dynamic evaluation model (e.g., dynamic evaluation model 152).

Evaluation response process 10 may process 238 the dynamic applicant information (e.g., dynamic applicant information 156) to generate one or more provider specific information sets (e.g., information sets 158, 160, 162, 164, 166) for one or more providers (e.g., providers 112, 116, 120, 124, 128 respectively), wherein the one or more provider specific information sets (e.g., information sets 158, 160, 162, 164, 166) are based, at least in part, upon one or more provider evaluation models (e.g., provider evaluation models 142, 144, 146, 148, 150).

As discussed above, each of the plurality of providers (e.g., providers 112, 116, 120, 124, 128) may require different pieces of information in order to generate an evaluation response (e.g., quotes/estimates/approvals 102, 104, 106, 108, 110), wherein examples of such pieces of information may include but are not limited to: first name, middle name, last name, home address, business address, age, gender, employment history, educational history, rental history, social security number, annual income, business type, known languages, skillsets, etc.

For example:
provider 112 (of plurality of providers 100) may require pieces of information 114 (e.g., A, B, D, J, K, L, O, R) in order to generate quote/estimate/approval 102;
provider 116 (of plurality of providers 100) may require pieces of information 118 (e.g., A, C, D, H, J, K, L, M) in order to generate quote/estimate/approval 104;
provider 120 (of plurality of providers 100) may require pieces of information 122 (e.g., A, C, E, L, M, N, O, Z) in order to generate quote/estimate/approval 106;
provider 124 (of plurality of providers 100) may require pieces of information 126 (e.g., A, E, J, K, P, R, S, Y) in order to generate quote/estimate/approval 108; and
provider 128 (of plurality of providers 100) may require pieces of information 130 (e.g., A, C, D, M, P, R, T, V) in order to generate quote/estimate/approval 110.

Accordingly and when evaluation response process 10 generates the provider specific information sets (e.g., information sets 158, 160, 162, 164, 166), evaluation response process 10 may generate these provider specific information sets (e.g., information sets 158, 160, 162, 164, 166) so that they provide the specific pieces of information required by the individual providers (e.g., providers 112, 116, 120, 124, 128).

Accordingly, evaluation response process 10 may generate:
information set 158 to include pieces of information A, B, D, J, K, L, O, R as required by provider 112 (of plurality of providers 100) and defined within provider evaluation model 142;
information set 160 to include pieces of information A, C, D, H, J, K, L, M as required by provider 116 (of plurality of providers 100) and defined within provider evaluation model 144;
information set 162 to include pieces of information A, C, E, L, M, N, O, Z as required by provider 120 (of plurality of providers 100) and defined within provider evaluation model 146;
information set 164 to include pieces of information A, E, J, K, P, R, S, Y as required by provider 124 (of plurality of providers 100) and defined within provider evaluation model 148; and
information set 166 to include pieces of information A, C, D, M, P, R, T, V as required by provider 128 (of plurality of providers 100) and defined within provider evaluation model 150.

When processing 238 the dynamic applicant information (e.g., dynamic applicant information 156) to generate one or more provider specific information sets (e.g., information sets 158, 160, 162, 164, 166) for one or more providers (e.g., providers 112, 116, 120, 124, 128), evaluation response process 10 may map 240 one or more data fields within the dynamic applicant information (e.g., dynamic applicant information 156) to one or more data fields within the one or more provider specific information sets (e.g., information sets 158, 160, 162, 164, 166).

As discussed above, mappings may be one-to-one, one-to-many, and/or many-to-one. For example and in a one-to-one mapping, a first name data field within dynamic applicant information 156 may be mapped to a first name data field within a specific information set (e.g., one of information sets 158, 160, 162, 164, 166). Further and in a one-to-many mapping, a full name data field within the dynamic applicant information 156 may be mapped to a first name data field and a last name data field within a specific information set (e.g., one of information sets 158, 160, 162, 164, 166). Additionally and in a many-to-one mapping, a first name data field and a last name data field within the dynamic applicant information 156 may be mapped to a full name data field within a specific information set (e.g., one of information sets 158, 160, 162, 164, 166).

When processing 238 the dynamic applicant information (e.g., dynamic applicant information 156) to generate one or more provider specific information sets (e.g., information sets 158, 160, 162, 164, 166) for one or more providers (e.g., providers 112, 116, 120, 124, 128), evaluation response process 10 may convert 242 data within the dynamic applicant information (e.g., dynamic applicant information 156) to a format compatible with the one or more provider specific information sets (e.g., information sets 158, 160, 162, 164, 166). For example and when converting 242 data within dynamic applicant information 156 to a format compatible with the one or more provider specific information sets (e.g., information sets 158, 160, 162, 164, 166), evaluation response process 10 may perform various operations, examples of which may include but are not limited to: converting words into abbreviations, converting abbreviations into words, transposing data, translating languages, and reformatting data (e.g., time formats/date formats).

Evaluation Response Process (Insurance Use Case)

As discussed above, the plurality of providers (e.g., plurality of providers 100) may include one or more of: a plurality of loan providers; a plurality of funding providers; a plurality of credit providers; a plurality of grant providers; a plurality of education providers; a plurality of rental providers; a plurality of mortgage providers; a plurality of employment providers; and a plurality of insurance providers. Therefore one specific and illustrative use case for evaluation response process 10 is applying for insurance with plurality of providers 100.

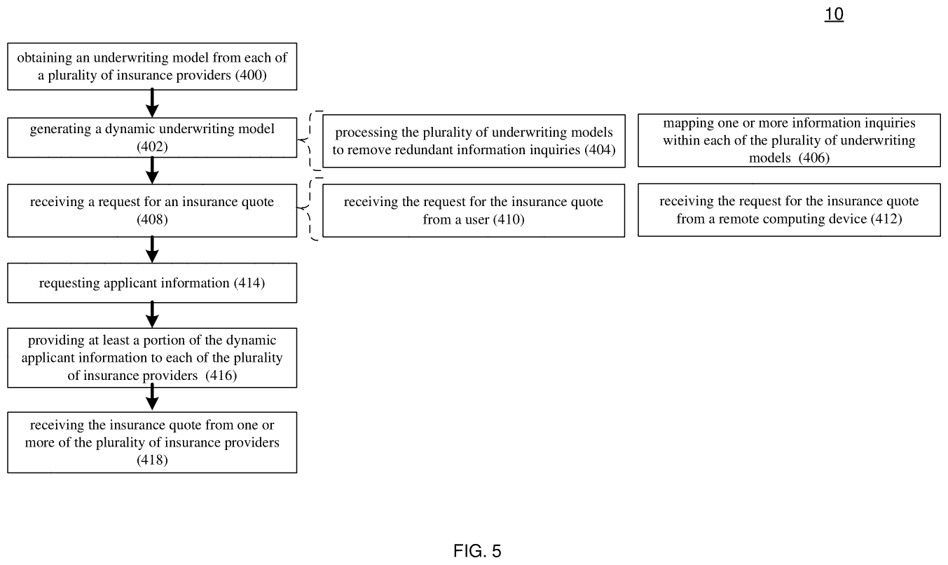

Accordingly and referring also to FIG. 5, evaluation response process 10 may obtain 400 an underwriting model from each of a plurality of insurance providers (e.g., providers 112, 116, 120, 124, 128), resulting in a plurality of underwriting models (e.g., provider evaluation models 142, 144, 146, 148, 150 respectively). Examples of the plurality of insurance providers (e.g., providers 112, 116, 120, 124, 128) may include but are not limited to a plurality of business/commercial insurance providers.

Each of the plurality of underwriting models (e.g., provider evaluation models 142, 144, 146, 148, 150 respectively) may include a plurality of information inquiries (e.g., information inquiries for pieces of information 114, 118, 122, 126, 130 respectively)

As discussed above:
provider 112 (of plurality of providers 100) may require pieces of information 114 (e.g., A, B, D, J, K, L, O, R) in order to generate quote/estimate/approval 102;
provider 116 (of plurality of providers 100) may require pieces of information 118 (e.g., A, C, D, H, J, K, L, M) in order to generate quote/estimate/approval 104;
provider 120 (of plurality of providers 100) may require pieces of information 122 (e.g., A, C, E, L, M, N, O, Z) in order to generate quote/estimate/approval 106;
provider 124 (of plurality of providers 100) may require pieces of information 126 (e.g., A, E, J, K, P, R, S, Y) in order to generate quote/estimate/approval 108; and
provider 128 (of plurality of providers 100) may require pieces of information 130 (e.g., A, C, D, M, P, R, T, V) in order to generate quote/estimate/approval 110.

Evaluation response process 10 may then generate 402 a dynamic underwriting model (e.g., dynamic evaluation model 152) based, at least in part, upon the plurality of underwriting models (e.g., provider evaluation models 142, 144, 146, 148, 150). The dynamic underwriting model (e.g., dynamic evaluation model 152) may include plurality of dynamically-defined information inquiries 154 (e.g., information inquiries for pieces of information A, B, C, D, E, H, J, K, L, M, N, O, P, R, S, T, V, Y, Z).

As discussed above, when generating 402 a dynamic underwriting model (e.g., dynamic evaluation model 152), evaluation response process 10 may process 404 the plurality of underwriting models (e.g., provider evaluation models 142, 144, 146, 148, 150) to remove redundant information inquiries defined within the plurality of underwriting models (e.g., provider evaluation models 142, 144, 146, 148, 150).

Further and as discussed above, when generating 402 a dynamic underwriting model (e.g., dynamic evaluation model 152), evaluation response process 10 may map 406 one or more information inquiries within each of the plurality of underwriting models (e.g., provider evaluation models 142, 144, 146, 148, 150 respectively) to one or more information inquiries within the dynamic underwriting model (e.g., dynamic evaluation model 152).

Evaluation response process 10 may receive 408 a request (e.g., request 54) for an insurance quote (e.g., one or more of quotes/estimates/approvals 102, 104, 106, 108, 110). An example of this insurance quote (e.g., one or more of quotes/estimates/approvals 102, 104, 106, 108, 110) may include but is not limited to a business/commercial insurance quote.

Receiving 408 a request (e.g., request 54) for an insurance quote (e.g., one or more of quotes/estimates/approvals 102, 104, 106, 108, 110) may include evaluation response process 10 receiving 410 the request (e.g., request 54) for the insurance quote (e.g., one or more of quotes/estimates/approvals 102, 104, 106, 108, 110) from a user (e.g., user 36).

Receiving 408 a request (e.g., request 54) for an insurance quote (e.g., one or more of quotes/estimates/approvals 102, 104, 106, 108, 110) may include evaluation response process 10 receiving 412 the request (e.g., request 54) for the insurance quote (e.g., one or more of quotes/estimates/approvals 102, 104, 106, 108, 110) from a remote computing device, such as a centralized computing system (not shown) associated with an insurance brokerage house (not shown) configured to interface with an API (e.g., API 56) of evaluation response process 10 exposed by computing device 12.

Evaluation response process 10 may request 414 applicant information based, at least in part, upon the dynamic underwriting model (e.g., dynamic evaluation model 152), thus defining dynamic applicant information (e.g., dynamic applicant information 156). The dynamic applicant information (e.g., dynamic applicant information 156) may include responses to plurality of dynamically-defined information inquiries 154 (e.g., information inquiries for pieces of information A, B, C, D, E, H, J, K, L, M, N, O, P, R, S, T, V, Y, Z), examples of which may include but are not limited to first name, middle name, last name, home address, business address, age, gender, employment history, educational history, rental history, social security number, annual income, business type, known languages, skillsets, etc.

Evaluation response process 10 may provide 416 at least a portion of the dynamic applicant information (e.g., dynamic applicant information 156) to each of the plurality of insurance providers (e.g., providers 112, 116, 120, 124, 128) for the purpose of generating the insurance quote (e.g., one or more of quotes/estimates/approvals 102, 104, 106, 108, 110).

Accordingly:
since provider 112 (of plurality of providers 100) requires pieces of information 114 (e.g., A, B, D, J, K, L, O, R) in order to generate quote/estimate/approval 102, evaluation response process 10 may provide 416 at least a portion of dynamic applicant information 156 (namely pieces of information A, B, D, J, K, L, O, R) to provider 112;
since provider 116 (of plurality of providers 100) requires pieces of information 118 (e.g., A, C, D, H, J, K, L, M) in order to generate quote/estimate/approval 104, evaluation response process 10 may provide 416 at least a portion of dynamic applicant information 156 (namely pieces of information A, C, D, H, J, K, L, M) to provider 116;
since provider 120 (of plurality of providers 100) requires pieces of information 122 (e.g., A, C, E, L, M, N, O, Z) in order to generate quote/estimate/approval 106, evaluation response process 10 may provide 416 at least a portion of dynamic applicant information 156 (namely pieces of information A, C, E, L, M, N, O, Z) to provider 120;
since provider 124 (of plurality of providers 100) requires pieces of information 126 (e.g., A, E, J, K, P, R, S, Y) in order to generate quote/estimate/approval 108, evaluation response process 10 may provide 416 at least a portion of dynamic applicant information 156 (namely pieces of information A, E, J, K, P, R, S, Y) to provider 124; and
since provider 128 (of plurality of providers 100) requires pieces of information 130 (e.g., A, C, D, M, P, R, T, V) in order to generate quote/estimate/approval 110, evaluation response process 10 may provide 416 at least a portion of dynamic applicant information 156 (namely pieces of information A, C, D, M, P, R, T, V) to provider 128.

Evaluation response process 10 may receive 418 the insurance quote (e.g., one or more of quotes/estimates/approvals 102, 104, 106, 108, 110) from one or more of the plurality of insurance providers (e.g., providers 112, 116, 120, 124, 128), wherein the insurance quote (e.g., one or more of quotes/estimates/approvals 102, 104, 106, 108, 110) may be based, at least in part, upon at least a portion of the dynamic applicant information (e.g., dynamic applicant information 156).

Accordingly:
quote/estimate/approval 102 may be based, at least in part, upon pieces of information 114 (e.g., A, B, D, J, K, L, O, R);
quote/estimate/approval 104 may be based, at least in part, upon pieces of information 118 (e.g., A, C, D, H, J, K, L, M);
quote/estimate/approval 106 may be based, at least in part, upon pieces of information 122 (e.g., A, C, E, L, M, N, O, Z);
quote/estimate/approval 108 may be based, at least in part, upon pieces of information 126 (e.g., A, E, J, K, P, R, S, Y); and
quote/estimate/approval 110 may be based, at least in part, upon pieces of information 130 (e.g., A, C, D, M, P, R, T, V).

Once received 418, evaluation response process 10 may provide these insurance quotes (e.g., one or more of quotes/estimates/approvals 102, 104, 106, 108, 110) to the requester (e.g., the user or another computer), wherein these insurance quotes insurance quotes (e.g., one or more of quotes/estimates/approvals 102, 104, 106, 108, 110) may be provided in their raw form (as received from the insurance providers) or may be homogenized/consolidated to form a report.

General

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A computer-implemented method, executed on a computing device, comprising:
obtaining an underwriting model from each of a plurality of insurance providers, resulting in a plurality of underwriting models;
generating a dynamic underwriting model based, at least in part, upon the plurality of underwriting models;
receiving a request for an insurance quote;
requesting applicant information based, at least in part, upon the dynamic underwriting model, thus defining dynamic applicant information; and
providing at least a portion of the dynamic applicant information to each of the plurality of insurance providers for the purpose of generating the insurance quote.

2. The computer-implemented method of claim 1 wherein:
the insurance quote is a business/commercial insurance quote;
the plurality of insurance providers is a plurality of business/commercial insurance providers; and
the insurance quote is a business/commercial insurance quote.

3. The computer-implemented method of claim 1 wherein the dynamic underwriting model includes a plurality of dynamically-defined information inquiries.

4. The computer-implemented method of claim 3 wherein the dynamic applicant information includes responses to the plurality of dynamically-defined information inquiries.

5. The computer-implemented method of claim 1 wherein each of the plurality of underwriting models includes a plurality of information inquiries.

6. The computer-implemented method of claim 5 wherein generating a dynamic underwriting model includes:
processing the plurality of underwriting models to remove redundant information inquiries defined within the plurality of underwriting models.

7. The computer-implemented method of claim 5 wherein generating a dynamic underwriting model includes:
mapping one or more information inquiries within each of the plurality of underwriting models to one or more information inquiries within the dynamic underwriting model.

8. The computer-implemented method of claim 1 wherein receiving a request for an insurance quote includes:
receiving the request for the insurance quote from a user.

9. The computer-implemented method of claim 1 wherein receiving a request for an insurance quote includes:
receiving the request for the insurance quote from a remote computing device.

10. The computer-implemented method of claim 1 further comprising:
receiving the insurance quote from one or more of the plurality of insurance providers, wherein the insurance quote is based, at least in part, upon the at least a portion of the dynamic applicant information.

11. A computer program product residing on a computer readable medium having a plurality of instructions stored thereon which, when executed by a processor, cause the processor to perform operations comprising:
obtaining an underwriting model from each of a plurality of insurance providers, resulting in a plurality of underwriting models;
generating a dynamic underwriting model based, at least in part, upon the plurality of underwriting models;
receiving a request for an insurance quote;
requesting applicant information based, at least in part, upon the dynamic underwriting model, thus defining dynamic applicant information; and
providing at least a portion of the dynamic applicant information to each of the plurality of insurance providers for the purpose of generating the insurance quote.

12. The computer program product of claim 11 wherein:
the insurance quote is a business/commercial insurance quote;
the plurality of insurance providers is a plurality of business/commercial insurance providers; and
the insurance quote is a business/commercial insurance quote.

13. The computer program product of claim 11 wherein the dynamic underwriting model includes a plurality of dynamically-defined information inquiries.

14. The computer program product of claim 13 wherein the dynamic applicant information includes responses to the plurality of dynamically-defined information inquiries.

15. The computer program product of claim 11 wherein each of the plurality of underwriting models includes a plurality of information inquiries.

16. The computer program product of claim 15 wherein generating a dynamic underwriting model includes:
processing the plurality of underwriting models to remove redundant information inquiries defined within the plurality of underwriting models.

17. The computer program product of claim 15 wherein generating a dynamic underwriting model includes:
mapping one or more information inquiries within each of the plurality of underwriting models to one or more information inquiries within the dynamic underwriting model.

18. The computer program product of claim 11 wherein receiving a request for an insurance quote includes:
receiving the request for the insurance quote from a user.

19. The computer program product of claim 11 wherein receiving a request for an insurance quote includes:
receiving the request for the insurance quote from a remote computing device.

20. The computer program product of claim 11 further comprising:
receiving the insurance quote from one or more of the plurality of insurance providers, wherein the insurance quote is based, at least in part, upon the at least a portion of the dynamic applicant information.

21. A computing system including a processor and memory configured to perform operations comprising:
obtaining an underwriting model from each of a plurality of insurance providers, resulting in a plurality of underwriting models;
generating a dynamic underwriting model based, at least in part, upon the plurality of underwriting models;
receiving a request for an insurance quote;
requesting applicant information based, at least in part, upon the dynamic underwriting model, thus defining dynamic applicant information; and
providing at least a portion of the dynamic applicant information to each of the plurality of insurance providers for the purpose of generating the insurance quote.

22. The computing system of claim 21 wherein:
the insurance quote is a business/commercial insurance quote;
the plurality of insurance providers is a plurality of business/commercial insurance providers; and
the insurance quote is a business/commercial insurance quote.

23. The computing system of claim 21 wherein the dynamic underwriting model includes a plurality of dynamically-defined information inquiries.

24. The computing system of claim 23 wherein the dynamic applicant information includes responses to the plurality of dynamically-defined information inquiries.

25. The computing system of claim 21 wherein each of the plurality of underwriting models includes a plurality of information inquiries.

26. The computing system of claim 25 wherein generating a dynamic underwriting model includes:
processing the plurality of underwriting models to remove redundant information inquiries defined within the plurality of underwriting models.

27. The computing system of claim 25 wherein generating a dynamic underwriting model includes:
mapping one or more information inquiries within each of the plurality of underwriting models to one or more information inquiries within the dynamic underwriting model.

28. The computing system of claim 21 wherein receiving a request for an insurance quote includes:
receiving the request for the insurance quote from a user.

29. The computing system of claim 21 wherein receiving a request for an insurance quote includes:
receiving the request for the insurance quote from a remote computing device.

30. The computing system of claim 21 further comprising:
receiving the insurance quote from one or more of the plurality of insurance providers, wherein the insurance quote is based, at least in part, upon the at least a portion of the dynamic applicant information.
